(19) United States
(12) Patent Application Publication
(10) Pub. No.: US 2005/0242070 A1
(43) Pub. Date: Nov. 3, 2005

(54) Plasma torch for microwave induced plasmas

(76) Inventor: Michael R. Hammer, Victoria (AU)

Correspondence Address: Varian Inc.;Legal Department, 3120 Hansen Way D-102, Palo Alto, CA, 94304, US

(21) Appl. No.: 10/515,797

(22) PCT Filed: May 21, 2003
(86) PCT No.: PCT/AU03/00615

§ 371 Date: Jun. 16, 2005

(30) Foreign Application Priority Data
May 21, 2002 (AU) PS 2454

(51) Int. Cl. B23K 9/00

(52) U.S. Cl. 219/121.48

(57) ABSTRACT

A Plasma torch (10) for microwave induced plasma spectrochemical analysis of a sample includes a nozzle (30) in an inlet (18) for the main plasma gas flow between outer tube (12) and intermediate tube (14) of the torch (10). The nozzle (30) increases the gas flow velocity in the sheathing gas layer for the plasma which is provided by the gas flow from the annular gap (22) between the tubes (12 and 14). The increased velocity of the gas in the sheathing gas layer “stiffens” that layer and thus better confines the microwave induced plasma (such better confinement not being necessary for an ICP torch). Thus the torch is of improved durability for a microwave induced plasma compared to an ICP torch. The sample injection (inner) tube (16) may have a reduced diameter outlet at its end (34) which is substantially level with the end (35) of intermediate tube (14) to improve injection of a sample into the microwave induced plasma. The inlet end (26) of the sample injection tube (16) may include a heater (36) to assist in preventing blockages in tube (16) near its outlet end.

### TECHNICAL FIELD

The present invention relates to a torch for plasma spectrochemical analysis, in particular a microwave induced plasma (MIP)torch.

### BACKGROUND

It is known that a plasma for spectrochemical analysis, for example for the elemental analysis of liquid samples, can be electrically excited, for example with radio frequency energy or microwave energy. Plasmas that are excited by radio frequency energy, that is, inductively coupled plasmas (ICP), are now well developed. In ICP spectrometry, the plasma is formed in a torch by induction from a surrounding coil excited with radio frequency energy, typically at between 20 and 50 MHz. The plasma forms as a hollow cylinder allowing injection of sample into the hollow central core of the plasma. Acceptable performance of ICP spectrometry requires close control of the gas flow regime including a sheathing gas flow around the plasma. In a typical ICP torch, regulation of the gas flows is ensured by a separate and independent gas control system, and the gas inlets into the torch are large relative to the amount of gas being admitted such that the presence of the torch creates very little back pressure.

Microwave induced plasma (MIP) spectrometry, however, is less well developed than ICP spectrometry, despite offering advantages, for example the availability of low cost, rugged and reliable microwave generators in the form of magnetrons. This is because the analytical performance of MIP systems has, until a recent development of the applicant, been significantly inferior to ICP systems. In the applicant's recently developed MIP system, a plasma torch is located within a microwave cavity for either the magnetic field component or both the magnetic and electric field components of the microwave energy to excite a plasma in the torch. A plasma having a tubular form of elliptical cross-section can be formed in the torch and the system has shown analytically useful performance approaching that obtainable with radio frequency ICP systems.

The inferior performance of MIP systems is due in large measure to the microwave induced plasma having different characteristics to a radio frequency ICP. Thus in a microwave induced plasma, the plasma thickness is much smaller and has a smaller core region compared to a radio frequency plasma (a microwave plasma exhibits substantially higher temperature vs. position gradients across a torch compared to a radio frequency ICP). These characteristics of a microwave induced plasma make the plasma more difficult to confine such that a torch as usually used for ICP spectrometry is generally not suitable for MIP spectrometry.

The discussion herein of the background to the invention is included to explain the context of the invention. This is not to be taken as an admission that any of the material referred to was part of the common general knowledge in Australia as at the priority date of any of the claims.

### SUMMARY OF THE INVENTION

The present invention seeks to provide a microwave induced plasma torch for spectrochemical analysis.

According to the invention there is provided a microwave induced plasma torch for spectrochemical analysis including
an outer tube, an intermediate tube and an inner tube, the inner tube being substantially coaxially located within the intermediate tube for injecting a first gas flow for carrying a sample for analysis into a microwave induced plasma produced in the torch,
an intermediate-gas inlet leading into the intermediate tube for admitting a second gas flow into the space between the inner tube and the intermediate tube for controlling the axial position of a microwave induced plasma produced in the torch,
an outer-gas inlet leading into the outer tube for supplying a third gas flow between the outer tube and the intermediate tube for providing a sheathing gas layer for a microwave induced plasma produced in the torch,
wherein the outer-gas inlet is offset from a central axis of the torch to impart a spiral flow to the supplied third gas as it moves along the torch to provide the sheathing gas layer,
and a restriction within the outer-gas inlet for increasing the gas velocity in the sheathing gas compared to the gas velocity upstream of said restriction to thereby increase the confining force of the sheathing gas layer on the microwave induced plasma, the restriction providing for flow rate regulation from a substantially constant pressure supply of the third gas.

In use, the increase in gas velocity creates a pressure drop across said restriction within the outer-gas inlet. Preferably the restriction has an orifice having a cross sectional area which is such that, relative to the cross sectional area of the outer gas inlet prior to the restriction and for a given third gas, a pressure reduction of between 50 to 200 kPa in the third gas when supplied to the outer gas inlet occurs across the restriction.

The increased velocity of the gas in the sheathing gas layer effectively “stiffens” that layer and thus better confines a microwave induced plasma. This sheathing gas layer provides a boundary layer of gas between the inner surface of the outer tube of the torch and the microwave induced plasma and thus keeps the plasma separated from that tube to prevent the tube from melting thereby improving the durability of the torch. The outer-gas inlet is located such that the direction of gas flow at the point of injection of the gas flow is offset from the centre line of the torch whereby the sheathing gas layer spins as it moves along the length of the torch. This rotation, that is, spiralling of the gas flow helps to stabilise the plasma and maintain its uniform tubular form.

The increase in gas velocity is preferably relatively high such that the rate of rotation of the gas sheathing layer is increased. The restriction for increasing the gas velocity acts to convert the potential energy inherent in the supply gas pressure to kinetic energy where the gas enters the torch. Consequently, for a relatively high increase in gas velocity in use, a significant pressure reduction occurs. This is done proximate to where the gas enters the torch otherwise the kinetic energy would be dissipated through turbulence in the tubing between the gas supply and the torch.

Preferably the restriction within the outer-gas inlet is a nozzle and this may be a venturi or of a more complex shape to deliver better energy conversion efficiency.

The pressure reduction due to the presence of the velocity increasing restriction associated with the outer-gas inlet exhibits a substantial if not dominant effect on regulation of the third gas flow to the microwave induced plasma, that is, the torch constitutes a major component in the regulation of the third gas flow to the microwave induced plasma. This is opposite to the situation in a typical ICP system, wherein the gas flow to the plasma is supplied to the torch by a control system designed to provide a constant flow rate and in which the torch has a negligible effect on the regulation of the gas flow. Thus the invention makes it possible to supply gas to the torch at constant pressure rather than constant flow rate, and to rely on the torch for flow regulation.

Accordingly the invention also provides a microwave induced plasma spectrochemical analysis system including
a microwave induced plasma torch as described hereinbefore,
a gas supply for supplying a plasma support gas to the outer-gas inlet of the torch,
wherein the gas supply supplies the plasma support gas at a substantially constant pressure,
whereby the flow rate of the third gas into the torch is regulated by the restriction within the outer-gas inlet for increasing the gas velocity in the sheathing gas layer.

As in a radio frequency ICP system, the microwave induced plasma torch includes an inner tube for injecting a sample for spectrochemical analysis into the core of the plasma. Such an inner tube is normally located substantially coaxially within the intermediate tube. It is more difficult to inject a sample into a microwave induced plasma than into a radio frequency plasma and to reduce this difficulty, the inner tube of a torch according to an embodiment of the invention may have a reduced diameter opening at its outlet tip. For example, whereas the preferred outlet opening for a radio frequency ICP torch is between about 1.4 mm and 2.5 mm for aqueous samples, for a torch for a microwave induced plasma using the same sample gas flow of about 1 litre per minute, the opening diameter may be between 0.9 and 1.4 mm. Additionally or alternatively, the outlet end of the inner tube may be extended to be closer to the microwave induced plasma than is typically the case for a radio frequency ICP torch. This means that the gas jet that contains sample will have less distance to bend or diffuse before encountering the microwave induced plasma. In a preferred embodiment of the invention, the outlet end of the inner tube is made substantially level with the end of the intermediate tube.

Another problem encountered in torches for both ICP and MIP, particularly for samples that contain high total dissolved solids (TDS), is that radiated energy from the plasma heats up the outlet end of the inner (that is, the sample injection) tube and can lead to blockage of that tube. That is, a small portion of the liquid droplets in a nebulised sample travelling through the sample injection tube inevitably contact the inner surface of the tube and tend to adhere thereto and are dried by the heated tube. The solid component of such droplets remains attached to the inner surface and this deposit slowly builds up progressively occluding the inner (sample injection) tube near or at its outlet opening. The effect is a slowly degrading signal, with the sensitivity becoming progressively worse. This is particularly a problem for a microwave induced plasma torch if the sample injection (inner) tube is extended to be closer to the microwave induced plasma and/or has a relatively smaller outlet opening, as described hereinbefore.

Another aspect of the invention seeks to avoid or at least reduce this blockage problem when aspirating samples containing high TDS.

Accordingly the invention furthermore provides
a torch for plasma spectrochemical analysis including
an outer tube, an intermediate tube and an inner tube, the inner tube being substantially coaxially located within the intermediate tube for carrying a first gas flow for conveying an aerosol of a nebulised sample liquid for injection through an outlet thereof into a plasma formed in the torch,
an intermediate-gas inlet leading into the intermediate tube for admitting a second gas flow into the space between the inner tube and the intermediate tube for controlling the axial position of a plasma produced in the torch,
an outer-gas inlet leading into the outer tube for supplying a third gas flow-between the outer tube and the intermediate tube for providing a sheathing gas layer for a plasma produced in the torch,
wherein the outer-gas inlet is offset from a central axis of the torch to impart a spiral flow to the supplied third gas as it moves along the torch to provide the sheathing gas layer,
and a heater associated with a section of the inner tube for heating an aerosol passing through that section to substantially completely evaporate liquid from the aerosol, the section of the inner tube being spaced from the outlet of the inner tube for the liquid to be substantially completely evaporated before the aerosol reaches the proximity of the outlet.

It should be noted that while one possibility is for the water to be removed (that is, the sample desolvated) this is not a necessary requirement for the aspect of the invention disclosed immediately above. It is only necessary that the water be kept in gaseous form.

The heater may be a part of the torch as such or it may be otherwise associated with the torch, that is, the heater may be located along a section of the sample inlet tube between the output of the spray chamber and the sample inlet port of the torch. The heater preheats the nebulised sample aerosol to evaporate its liquid phase leaving dry particles of sample suspended in the gas stream. If such dry particles contact the wall of the injection (that is, the inner) tube, they slide over that wall without adhering thereto thus avoiding or at least reducing the blockage problem.

Preferably a heater of a torch according to the “another aspect” of the invention as described, hereinbefore is included with a microwave induced plasma torch of the aspect of the invention as first described hereinbefore.

For a better understanding of the invention and to show how the same may be carried into effect, a preferred embodiment thereof will now be accompanying drawings.

### BRIEF DESCRIPTION OF DRAWINGS

FIG. 1 schematically illustrates a preferred embodiment of a microwave induced plasma torch according to the invention.

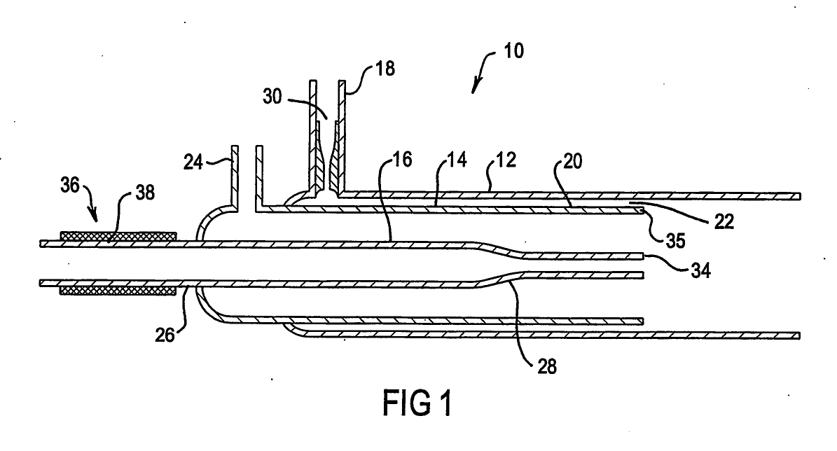

FIGS. 2A, B and C illustrate steps for forming a nozzle in the gas inlet of an embodiment of a microwave induced plasma torch according to the invention.

### DESCRIPTION OF PREFERRED EMBODIMENTS

A microwave induced plasma torch 10 according to an embodiment of the invention comprises three concentric tubes, typically of quartz, namely an outer tube 12, an intermediate tube 14 and an inner tube 16. The outer tube 12 includes an outer-gas inlet 18 for supplying a gas flow (hereinbefore “a third gas flow”) between the outer tube 12 and the intermediate tube 14. The intermediate tube 14 has an end section 20 which together with the outer tube 12 defines an annular gap 22 for passage of the third gas. The third gas flow between the outer and intermediate tubes 12 and 14 (termed the main flow or plasma support gas flow) establishes a sheathing gas layer for a microwave induced plasma produced in the torch which separates the microwave induced plasma from the inner surface of the quartz outer tube 12 and thus stops this tube from melting. The outer-gas inlet 18 is arranged for the gas to be injected offset from the centre line of the torch such that the flow spirals or spins as it moves along the length of the microwave induced plasma torch 10. This spiral flow of the gas sheath helps to stabilise the microwave induced plasma and maintain its uniform tubular form. The annular gap 22 is such as to help to maintain the sheathing gas layer as a thin laminar flow bordering the inner wall of the outer tube 12. The end section 20 of the intermediate tube 14 may be of enlarged diameter (not shown) compared to the remainder of the tube 14 to define a smaller annular gap 22.

Intermediate tube 14 includes an intermediate-gas inlet 24 for supplying a second gas flow between the intermediate tube 14 and inner tube 16. This flow is used to control the axial position of the microwave induced plasma and in particular to keep it separated from the ends 35 and 34 respectively of the intermediate tube 14 and inner tube 16.

The inner tube 16 is for containing a flow of gas (hereinbefore “a first gas flow”) for carrying sample aerosol supplied to its inlet end 26 and injects this into the core of the microwave induced plasma. This tube 16 may include a gradual taper 28 along a substantial portion of its length to improve the torch performance as disclosed in the applicant's prior application No. PCT/AU02/00386 (WO 03/005780 A1) entitled “Plasma Torch”.

For excitation of a microwave induced plasma, torch 10 would be suitably associated with means for applying a microwave electromagnetic field to the torch, for example, torch 10 may be appropriately located through a resonant cavity to which microwave energy is supplied. A plasma may be initiated by momentarily applying a high voltage spark (by means known in the art and not shown) to the gas entering through inlet 18.

According to an aspect of the invention, a restriction 30 is located within the outer-gas inlet 18 for increasing the gas velocity in the sheathing gas layer compared to the gas velocity therein in the absence of said restriction.

In this embodiment restriction 30 is a nozzle formed within-the outer-gas inlet 18. The nozzle 30 has the effect of increasing the velocity of the spiral gas flow and this serves to “stiffen” the sheathing gas layer upon exit from annular gap 22 and thus better confines a microwave induced plasma than would a typical torch arrangement that is used for ICP spectrometry.

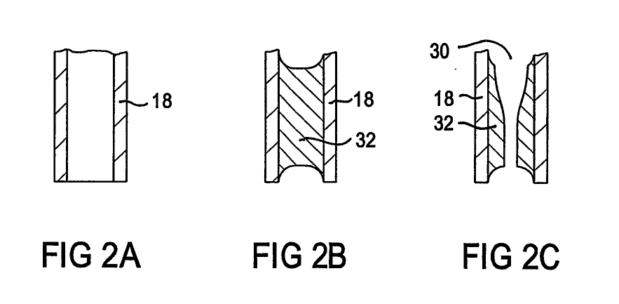

One way of creating the nozzle 30 is to mould it directly as part of the gas inlet 18. As the microwave induced plasma torch 10 is typically constructed of quartz which is a relatively difficult material to mould with accuracy, the nozzle may be formed by reducing the quartz outer-gas inlet 18 onto a piece of tungsten wire of appropriate diameter to achieve the quite close tolerancing that is required in the creation of the nozzle 30. An alternative approach is to machine the nozzle 30 as a separate component which is either inserted and sealed into the gas inlet tube 18 or replaces the gas inlet tube 18. A third and convenient alternative is to fill part or all of the length of the outer-gas inlet tube 18 with a potting material such as an epoxy resin 32 (see FIG. 2B. FIG. 2A shows the initial outer-gas inlet tube 18), curing the potting material 32 and then machining the nozzle 30 in the cured material 32 (see FIG. 2C). This approach has proven to be simple and effective. It also eliminates the need for dimensional accuracy in the quartz inlet tubing 18.

Where a nozzle 30 is formed as a simple restriction, for a third gas flow of 15 litres per minute the preferred throat diameter of the nozzle is between 0.9 and 1.3 mm, although it is to be understood that different gas flow rates or different nozzle designs can result in different throat diameters. Typical pressure drops are in the range 50 to 200 kPa.

Typically in a torch for radio frequency ICP spectrometry, the end 34 of the inner (sample injection) tube 16 is spaced back from the end 35 of the intermediate tube 14 to increase its separation from the plasma and thus reduce the temperature at its end 34. This reduction in temperature both reduces the risk of melting the inner tube 16 and reduces the likelihood of premature evaporation of sample which would have the effect of depositing the dissolved solids near the tube end 34 thus blocking the sample injection tube. However, in a preferred feature of the present invention, the end 34 is extended to be substantially level (for example within 2 mm) with the end 35 of intermediate tube 14. This improves the injection of sample into a microwave induced plasma, which injection is more difficult than for a radio frequency ICP. The outlet diameter at end 34 for a sample gas flow of about 1 litre per minute is preferably between 0.9 and 1.4 mm.

A further feature of the invention, which assists in preventing blockage in proximity to end 34 of inner tube 16, particularly if that end 34 is substantially level with the end 35 of intermediate tube 14, is to associate a heating means 36 with a section 38 of the inlet 26 for the inner tube 16. The tube section 38 may be constructed from a piece of chemically and thermally resistant tube such as for example a quartz or glass tube having a resistance wire wound around the outside and high temperature insulation covering the resistance wire and the tube. The wire is heated by passing an electrical current through it and the sample is heated as it passes through the tube section 38 from one end to the other. As a non-limiting example of typical dimensions the following arrangement has been found to be effective. A quartz tube 38 of 9 mm inner diameter×11 mm outer diameter×150 mm long with the middle 80 mm wound with 25 turns of flat nichrome wire 1.6 mm wide by 0.2 mm thick. The unheated ends of this quartz tube 38 are present to ensure that the ends where hose connection is made remain cool. The coil resistance was 4 ohms and was heated using a 12 volt AC power supply thus delivering 36 watts. The whole assembly was enclosed in a block of fibrous ceramic insulation 20 mm×20 mm×90 mm outside dimensions. It is to be understood however that many other geometries could be effective without departing from the scope of the present invention.

It is to be understood that the invention includes a torch 10 (which may be modified for ICP) having a heater 36 but which does not include a restriction 30 for increasing the downstream gas velocity. Such a torch 10 with a heater 36 may be used for MIP or ICP spectroscopy.

As an indication of the effectiveness of the heater 36, the torch 10 was first run with the tube section 38 in place but with the heating coil unenergised. Seawater with 3.5% total dissolved solids (TDS) was introduced and degrading sensitivity was observed within 1 minute of the start of introduction of the sample. Signal degradation progressed until total blockage occurred approximately 10 minutes after the start of introduction of the sample. The torch was then cleaned and the experiment repeated but with the heating coil 36 energised. This time, no indication of blockage was observed after 15 minutes continuous introduction of the sample, and when the torch was subsequently disassembled and examined, there was no sign of any deposit near the tip end 34 of the injector 16. A sample containing 10% TDS was then introduced continuously for 20 minutes with no sign of blockage.

The invention described herein is susceptible to variations, modifications and/or additions other than those specifically described and it is to be understood that the invention includes all such variations, modifications and/or additions which fall within the scope of the following claims.

1. A torch for plasma spectrochemical analysis including an outer tube, an intermediate tube and an inner tube, the inner tube being substantially coaxially located within the intermediate tube for injecting a first gas flow for carrying a sample for analysis into a plasma produced in the torch,
an intermediate-gas inlet leading into the intermediate tube for admitting a second gas flow into the space between the inner tube and the intermediate tube for controlling the axial position of the plasma produced in the torch,
an outer-gas inlet leading into the outer tube for supplying a third gas flow between the outer tube and the intermediate tube for providing a sheathing gas layer for the plasma produced in the torch,
wherein the outer-gas inlet is offset from a central axis of the torch to impart a spiral flow to the supplied third gas as it moves along the torch to provide the sheathing gas layer,
and means associated with the outer-gas inlet for increasing the gas velocity in the sheathing gas compared to the gas velocity upstream of said means to thereby increase the confining force of the sheathing gas layer on the plasma.

2. A torch as claimed in claim 1, wherein the means associated with the outer-gas inlet is a restriction within the inlet.

3.

4. A torch as claimed in claim 3, wherein the nozzle is formed in situ from a cured potting material within the outer-gas inlet.

5. A torch as claimed in claim 1, wherein the means associated with the outer-gas inlet is such as to, in use, cause a relatively high increase in the gas velocity.

6. A torch as claimed in claim 1, wherein the intermediate and inner tubes terminate at respective ends within the outer tube, and wherein the ends of the intermediate and inner tubes are substantially level, for example within about 2 mm.

7. A torch as claimed in claim 6, wherein the inner tube has an outlet that is of reduced diameter compared to an inlet end of the inner tube.

8. A torch as claimed in claim 1, wherein the inner tube includes an inlet section, and a heating means is associated with said inlet section for heating an aerosol passing through that section to substantially completely evaporate liquid from the aerosol, the section of the inner tube being spaced from the outlet for the liquid to be substantially completely evaporated before the aerosol reaches the proximity of the outlet.

9. A torch as claimed in claim 8, wherein the heating means is an electrical resistance heater.

10. A torch as claimed in claim 9, wherein the electrical resistance heater is provided by an electrical coil around the inlet section.

11. A torch for plasma spectrochemical analysis including
an outer tube, an intermediate tube and an inner tube, the inner tube being substantially coaxially located within the intermediate tube for carrying a first gas flow for conveying an aerosol of a nebulised sample liquid for injection through an outlet thereof into a plasma formed in the torch,
an intermediate-gas inlet leading into the intermediate tube for admitting a second gas flow into the space between the inner tube and the intermediate tube for controlling the axial position of a plasma produced in the torch,
an outer-gas inlet leading,into the outer tube for supplying a third gas flow between the outer tube and the intermediate tube for providing a sheathing gas layer for a plasma produced in the torch,
wherein the outer-gas inlet is offset from a central axis of the torch to impart a spiral flow to the supplied third gas as it moves along the torch to provide the sheathing gas layer,
and a heating means associated with a section of the inner tube for heating an aerosol passing through that section to substantially completely evaporate liquid from the aerosol, the section of the inner tube being spaced from the outlet of the. inner tube for the liquid to be substantially completely evaporated before the aerosol reaches the proximity of the outlet.

12. A torch as claimed in claim 11, wherein the heating means is an electrical resistance heater.

13. A torch as claimed in claim 12, wherein the electrical resistance heater is provided by an electrical coil round the inlet section.

14. A microwave induced plasma spectrochemical analysis system including a torch as claimed in claim 1,
a gas supply for supplying a plasma support gas to the outer-gas inlet of the torch,
wherein the gas supply supplies the plasma support gas at a substantially constant pressure,
whereby the flow rate of the plasma support gas into the torch is regulated by the means associated with the outer-gas inlet for increasing the gas velocity in the sheathing gas layer.
